(19) United States
(12) Patent Application Publication
(10) Pub. No.: US 2002/0101540 A1
(43) Pub. Date: Aug. 1, 2002

(54) Channel selection device for use in digital/analog broadcasting receiver and digital/analog broadcasting receiver equipped with the same

(75) Inventors: Toshihiro Takagi, Osaka (JP); Manabu Yamamoto, Mukou-shi (JP); Takahiro Katayama, Osaka (JP); Yusuke Nishida, Ikoma-shi (JP)

Correspondence Address: Crowell & Moring, L.L.P., P.O. Box 14300, Washington, DC, 20044-4300, US

(73) Assignee: Funai Electric Co., Ltd.

(21) Appl. No.: 10/058,149

(22) Filed: Jan. 29, 2002

(30) Foreign Application Priority Data
Jan. 31, 2001 (JP) 2001-24505

(51) Int. Cl. H04N 5/44

(52) U.S. Cl. 348/553; 348/569

(57) ABSTRACT

A channel selection device used in a digital/analog broadcasting receiver changes a channel according to a channel upward/downward changing instruction by selectively using the following procedures. The first procedure B is used to search for a desired physical channel when there is no channel information; the second procedure A is used to select a channel when there is information of the current physical channel; the third procedure is used when a channel to which the current channel is changed upward/downward exceeds the current physical channel range; and the fourth procedure D is used when information of all the channels is held. Thus, it is possible to appropriately select a channel automatically and also to obtain the channel information automatically when the channel is changed.

### BACKGROUND OF THE INVENTION

The invention relates to a channel selection device used in a television receiver for receiving a digital/analog broadcast and a digital/analog broadcasting receiver equipped with the same.

Conventionally, there has been available such a digital/analog broadcasting receiver that is capable of selecting a channel to display a list of channel information obtained by analyzing a broadcasting signal in order to facilitate channel selecting operations (see, for example, Japanese Unexamined Patent Publication No. 55-26760). By digital broadcasting, also, a plurality of programs is put in one physical channel in a time division multiple access (TDMA) manner and broadcast so that the reception side can select a desired program of channel using a broadcasting signal containing channel selection information; therefore if the user obtains all the channel selection information each time he switches the program, it takes long time in channel selection. To solve this problem, there is such a receiver available that permits a user who wishes to select a channel to use the past channel selection information he obtained in the past to thereby obtain his necessary channel information rapidly (see Japanese Unexamined Patent Publication No. 11-275476).

In the ATSC (Advanced Television Systems Committee) Standard of the North America Digital Broadcasting, besides a prior art analog broadcast, there are originated a BS (Broadcasting Satellite) digital broadcast capable of high-picture-quality and multi-channel broadcasting and a digital broadcast represented by the CS (Communications Satellite) digital broadcast, each of which digital broadcasts is originated in a carrier wave in a predetermined frequency band through a physical channel different from that for analog broadcasting, thus generally containing many contents. Other digital broadcasts originated from the same broadcasting station or the same system of broadcasting station as the prior art analog broadcasting station are managed so that the station can be selected and displayed through a virtual channel assigned the same channel numbers as the prior art analog broadcasting channel numbers in order to facilitate the operations of the users accustomed to these prior art channel numbers.

The digital broadcasting virtual channels comprise one main channel and sub-channels which are headed by the main channel number to originate one or a plurality of contents, which channels are given in a hierarchy. The configuration of the sub-channels changes with a broadcasting time band, one of which is exemplified in FIG. 7 which shows a configuration of the sub-channels in a time band (8:00 PM to 12:00 PM) that has a main channel “4”.

In FIG. 7, in broadcasting, sub-channels of Nos. 0 to 4 are selected for 8:00 to 9:00 PM, sub-channels of Nos. 0 and 1 are selected for 9:00 to 10:00 PM, sub-channels of Nos. 0 to 4 are selected for 10:00 to 11:00 PM, and sub-channels of Nos. 0 to 3 are selected for 11:00 to 12:00 PM. Of these, the sub-channel of No. 0 (physical channel No. of 4-0) involves analog broadcasting according to the NTSC (National Television Systems Committee) Standard, while the sub-channels of Nos. 1 to 4 (virtual channels Nos. 4-1 through 4-4) involve digital broadcasting. Also, a TV program broadcast through the channel 4-0 is a prior art analog-broadcast one, an SD (Standard Definition) program broadcast through the channels 4-1 through 4-4 are digital broadcast standard-picture-quality one, and an HD (High Definition) program broadcast through the channel 4-1 is a digital broadcast high-picture-quality one.

There is such a prior art digital/analog broadcasting receiver's channel selection device that decodes and analyzes a broadcasting signal to obtain a VCT (Virtual Channel Table) containing virtual channel information based on PSIP (Program System Information protocol) and hold a channel map storing this table, so that when the user changes or select a channel, based on this channel map, an EPG (Electric Program Guide) functioning as an interface is used to display a channel selection display to thereby operate the key (e.g., UP key/DOWN key) at the body's operation panel or remote-control panel, thus enabling him to change or select the channel.

As described above, a digital/analog broadcast, especially a sub-channel broadcast fluctuates in actual situation comparatively soon owing to, for example, temporary suspension in transmission. As described in the above-mentioned Japanese Unexamined Paten Publication No. 11-275476, even when the user uses already obtained channel selection information or store the channel information as a channel map to select a channel based thereon, only by changing the selection channel, inappropriately he may fail in selection if the current channel is broadcasting nothing therethrough. Although an analog broadcasting receiver is capable of selecting any channel only by changing the frequency, a digital/analog broadcasting receiver does not involve such an operation and may come in such a type that updates the information of all the channels at a time or that selects a specific channel when the channel map is cleared.

### SUMMARY OF THE INVENTION

This invention is made to solve the above-mentioned problems and it is an object of the invention to provide such a channel selection device used in a digital/analog broadcasting receiver and a digital/analog broadcasting receiver equipped with the same that is capable of automatically selecting an appropriate channel corresponding to how the channel data is held or how the channel is changed by the user and also that is capable of automatically obtaining the channel information when the channel is changed.

In order to achieve the above-mentioned object, the channel selection device used in a digital/analog broadcasting receiver comprises: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one main channel, one or a plurality of sub-channels for originating contents therethrough and also having a VCT (Virtual Channel Table) containing virtual channel information providing the sub-channels with a correlation with an analog broadcasting physical channel, characterized in that, the control unit, when trying to select a channel based on a channel upward/downward changing instruction sent from the input device, appropriately uses any one of the following four techniques of: a first technique, by which when there is no channel information in the memory, the frequency is shifted to search for a desired physical channel to thereby select a channel contained in a detected physical channel and also store information of the channel in the channel map; a second technique, by which when there is channel information of a current physical channel in the memory, a VCT thereof is referenced to select a sub-channel in the physical channel; a third technique, by which the first technique is employed when a channel to which the current channel is upward/downward changed by the second technique goes out of the current physical channel range; and a fourth technique, by which when information of all the channels is stored in the channel map in the memory, it is taken either a method of selecting a desired channel in referring to the channel map, or a method of selecting a desired channel based on the physical channel information in the channel map among the channels over a plurality of physical channels and of employing the second technique of selecting a desired channel among the channels in the same physical channel.

In accordance with a feature of the invention, when the device has received a channel upward/downward changing instruction but cannot find channel information in the memory, it searches for a desired physical channel to which the current channel is to be changed, and selects a channel contained therein and stores its channel information in a channel map (technique 1). If, in this case, the detected physical channel was digital, the device obtains sub-channel information from its VCT, to select the relevant sub-channel. If the detected physical channel was analog, on the other hand, the device selects the relevant channel. If it has found channel information of the current physical channel, the device refers to its VCT to thereby select a sub-channel (technique 2). If a channel to which the current channel is to be upward/downward changed goes out of a storage range of the memory, the device employs the above-mentioned technique B for channel selection (technique 3). Also, if the channel information (VCT) contained in all the physical channels has been stored in a channel map, the device refers to it for channel selection (technique 4). This technique 4 may combine a method, for channel changing over physical channels, of searching a plurality of physical channels for a channel to be selected on the basis of the physical channel information of a channel map and a method, for channel changing within a physical channel, of employing the above-mentioned technique 2. By executing any one of these techniques, the user needs only to operates channel upward/downward changing in order to store the channel information in the memory automatically.

In accordance with another feature of the invention, when a channel upward/downward changing instruction is given, the channel is appropriately changed upward/downward and, each time the user has changed the channel, the channel information is stored in the memory automatically. With this, the ATSC/NTSC receiver is capable of selecting a channel by channel upward/downward changing operations.

In accordance with a further feature of the invention, a digital signal involves for its broadcasting one or plurality of sub-channels to originate contents therethrough for each physical channel and these sub-channels are assigned a virtual channel relating to an analog broadcasting channel number, so that the user accustomed to analog broadcasts can selects his desired channels without feeling a sense of incompatibility. When having received a channel upward/downward changing instruction from the input device, a desired channel is selected using any ones of first through fourth procedures appropriately corresponding to the channel changing contents and how the data table is held in the memory. According to the first procedure, a sub-channel in the current main channel is to be changed, the device refers to a VCT in the current physical channel to thereby select an upward/downward sub-channel. The second through fourth procedures are used to change the main channel; for example, according to the second procedure, when there is no channel data of a main channel to which the current main channel is to be changed and its sub-channels, the device shifts the reception frequency upward/downward to thereby search other physical channels to thereby refers to their VCTs, thus selecting a sub-channel having the largest/smallest sub-channel number. According to the third procedure, if there is channel data of a main channel to which the current main channel is to be changed but no sub-channel data, the device refers to the main channel data and changes it and then refers to a VCT of the corresponding physical channel to thereby select a sub-channel having the largest/smallest sub-channel number. According to the fourth procedure, if there is a channel data of a main channel to which the current main channel is to be changed and also sub-channel data, the device refers to them to thereby change the main channel and the sub-channel, thus selecting a channel. These procedures make it possible to appropriately change the channel upward/downward even with a digital/analog broadcast reception system.

### BRIEF DESCRIPTION OF THE DRAWINGS

FIG. 1 is a block component diagram for showing a digital/analog broadcasting receiver having a channel selection device according to one embodiment of the invention.

FIG. 2 is a plan view for showing a remote controller which constitutes part of the channel selection device.

FIG. 3 is a chart showing a channel information in the channel selection device.

FIG. 4 is a flowchart for showing operations with the channel selection device.

FIGS. 5A and 5B are illustrations for showing broadcasting channel configurations.

FIG. 6 is a flowchart for showing operations different from those of FIG. 4 of the channel selection device.

FIG. 7 is an illustration for showing a channel configuration for digital/analog broadcasts.

### DETAILED DESCRIPTION OF THE PREFERRED EMBODIMENT OF THE PRESENT INVENTION

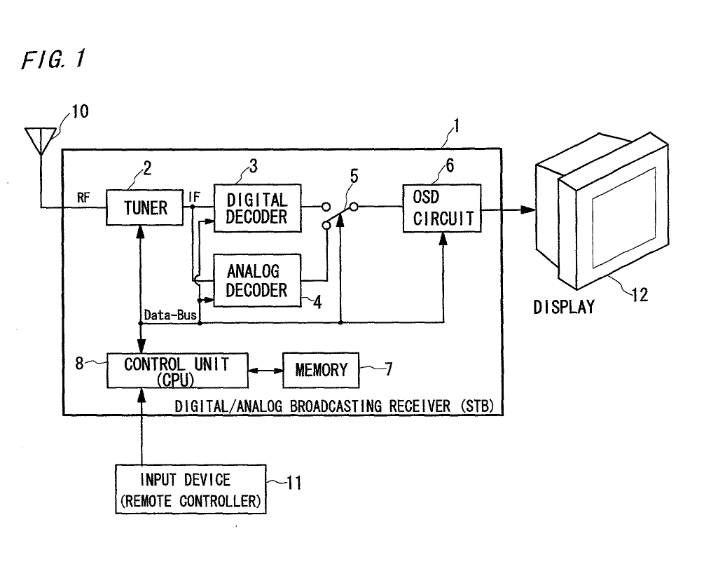

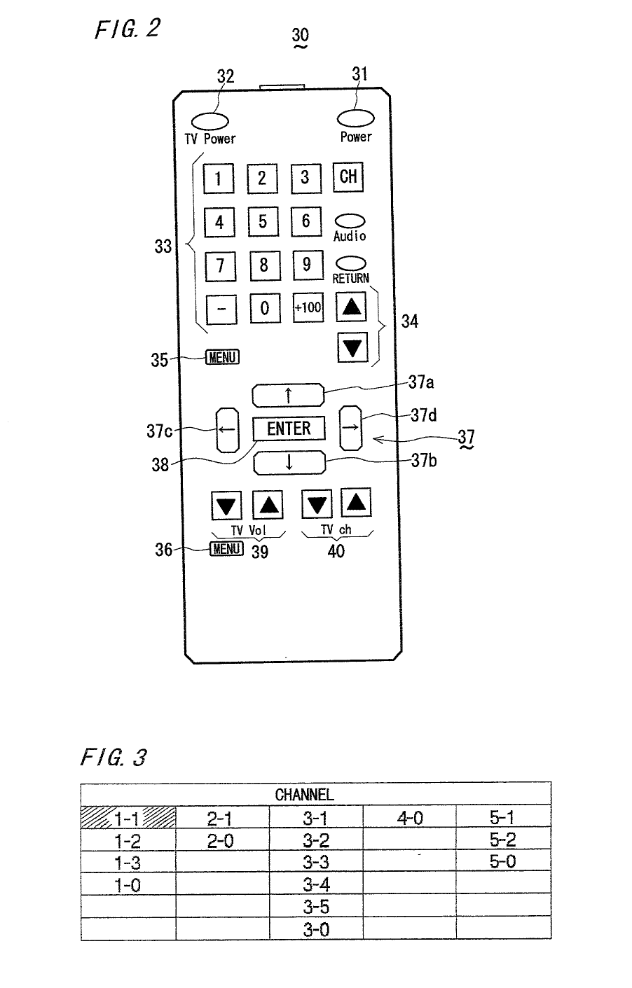

The following will describe a digital/analog broadcasting receiver having a channel selection device related to one embodiment of the invention with reference to the drawings. FIG. 1 is a block diagram of the digital/analog broadcasting receiver (hereinafter called receiver). The receiver 1 is a set top box (STB) that receives at an antenna 10 an encoded radio-frequency (RF) digital/analog broadcasting signal originated from a TV broadcasting station to then display a list of the channel information which can be received by a display device 12 for displaying on a display an video signal contained in the broadcasting signal corresponding to operations for channel information display by the user by use of the body button or an input device 11 such as a later-described remote controller 30 shown in FIG. 2.

The receiver 1 comprises a tuner 2 for receiving a digital/analog broadcasting signal which is present in a frequency band corresponding to a desired channel, a digital decoder 3 and an analog decoder 4 for decoding the digital/analog broadcasting signal received at the tuner 2, a switch 5 for switching the broadcasting signals decoded by the digital decoder 3 and the analog decoder 4, an OSD circuit for providing predetermined On-Screen Display (hereinafter abbreviated as OSD) at a display 12, a memory 7 for storing the originated frequencies of each digital broadcasting main channel and the channel configuration information, and a control unit 8 consisting of a CPU for controlling these sections of the receiver.

The tuner 2 is supplied with a digital/analog broadcasting signal received through the antenna 10 to then select a channel according to an instruction the user input to the control unit 8 from the input device 11 to thereby receive a digital/analog broadcasting signal of a frequency band corresponding to an input channel and modulate it into an intermediate frequency (IF) signal and then output it to the digital decoder 3 and the analog decoder 4. The digital decoder 3 and the analog decoder 4 decode the broadcasting signal received by the tuner 2. In the digital broadcasting channel configuration, each main channel is assigned each frequency band so that the sub-channels of the same main channel are used to originate broadcasting signals of the same frequency. However, the physical channels are different even in digital broadcasting using a virtual channel headed by the same number as that of analog broadcasting, so that if a user-selected channel through which the broadcasting signal is originated by a carrier wave of a different frequency band is of digital broadcasting (if the sub-channels are not of number “0”), the broadcasting signal is decoded by the digital decoder 3. If the user-selected channel is of analog broadcasting (if the sub-channels are of number “0”), the signal is decided by the analog decoder 4.

The switch 5 receives an instruction from the control unit 8 to then output to the OSD circuit 6 a broadcasting signal decided by either the digital decoder 3 or the analog decoder 4. The OSD circuit 6 in turn receives an instruction from the control unit 8 to then output the broadcasting signal to the display 12 and also output an OSD display signal for displaying a list of the receivable channel information. The memory 7 stores the information of each channel's frequency band and the channel configuration information as well as the information of OSD display at the time of shipment of the receiver.

The control unit 8 receives a user's input through the input device 11 to then control the sections through a data bus (Data-Bus) and cause the memory 7 to store the information of each channel's frequency band and the received channel information, thus referring to the information as occasion demands, for example, when a channel is selected.

Also, the control unit 8 receives a user's instruction for channel changing to then cause the tuner 2 to receive a broadcasting signal containing channel configuration information and then analyzes a VCT (Virtual Channel Table) given as the channel information obtained by decoding this broadcasting signal at the digital decoder 3, thus obtaining a status signal contained therein. This status signal generally contains all the digital/analog sub-channel information of a virtual channel. The control unit 8, therefore, can analyze that VCT to thereby obtain a virtual channel number consisting of the same number (main channel) as the previous channel number given to the same of the same system of broadcasting station originating the above-mentioned digital/analog broadcasting signal and a sub-channel number. That is, the control unit 8 can collectively obtain the digital/analog channel information originated from the same or the same system of broadcasting station. The control unit 8 stores thus obtained status signal in the memory 7, thus storing the channel information therein.

Further, the control unit 8, when having received a user's instruction from the input device 11, refers to the data stored in the memory 7 to then indicate in OSD display such a later-described channel information table as shown in FIG. 3 at the display 12 and also moves a displayed cursor for channel selection to thereby display a video program of a selected broadcast.

The display 12 may be a display of a television receiver, a CRT, or a flat panel display such as an LCD (Liquid Crystal Display) or PDP (Plasma Display Panel). Although not shown, the receiver 1 is equipped with a D/A converter circuit for converting a digital signal into an analog one so that the signal for the OSD display or image display is converted by this D/A converter circuit into an analog signal and then output to the display 12. Also, the D/A converter circuit may be built in the display 12. Note here that to display contents on the flat panel display, the signal bypasses the D/A converter signal and is output as digital signal as it is.

The input device 11 is used to input a user's instruction to the control unit 8. The input device 11 may come in the body button provided on the front panel of the receiver 1 or a remote controller 30 such as shown in FIG. 2. In FIG. 2, the remote controller 30 is adapted to give an instruction in the form of an ultraviolet ray etc. to operate the receiver 1 and the television receiver, comprising power keys 31 and 32 for turning ON and OFF respectively the power of the receiver 1 and the television receiver, a numeric keypad 33 for inputting a channel number of the receiver 1, a channel UP/DOWN key pair 34 for changing the channel, menu keys 35 and 36 for calling a menu display of the receiver 1 and the television receiver respectively, keys 37 (37a to 37d) for moving the cursor in any desired directions, an entry (ENTER) key 38 for assuring an input, a sound-volume UP/DOWN key pair 39 for adjusting a sound volume of the television receiver, and a channel UP/DOWN key pair 40 for changing the television receiver channel.

Among the keys 37, the RIGHT/LEFT keys 37c and 37d are assigned for changing the main channel, while the UP/DOWN keys 37a and 37b are assigned for moving the cursor to thereby switch the sub-channel in each main channel. The assignment of the UP/DOWN keys 37a and 37|b and the RIGHT/LEFT keys 37c and 37d may be reversed.

The following will describe an example of a hierarchical construction of a channel information table (channel map) held in the memory 7 of the receiver 1 with reference to FIG. 3. A list of this channel information can be given as an EPG (Electric Program Guide) in OSD display at the display 12 when the user gives an instruction to the control unit 8 using the menu key 35 on the remote controller 30. The channel information is comprised of the channel information of an analog broadcast (“1-0”, “2-0”, “3-0”, . . . ) and the channel information of a digital broadcast provided with a virtual channel headed by the same number as this analog broadcast's main channel number (“1-1”, “1-2”, “1-3”, “2-1”, “3-1”, “3 -2”, . . . ). In the list, the main channels are arranged sequentially in the horizontal direction and vertically are sequentially arranged the digital broadcasting virtual channels (in an ascending order) and analog broadcasting channels for each channel from the top. The shaded portions in FIG. 3 indicate the cursor. Note here that the virtual channel can be used to thereby permit the user accustomed to analog broadcasts to select his desired channel without feeling a sense of incompatibility.

Also, in changing the channel based on an instruction for main channel changing, if the main channel contains a plurality of sub-channels, the control unit 8 is to preferentially select the smallest channel number of sub-channel “1” of the digital sub-channels. In operation, sub-channel “0” involves an analog broadcast and sub-channel “1” involves a digital broadcast of the same contents in transmission, so that in viewing of a digital broadcast, sub-channel “1” is considered in concept to have comparatively a high channel selection desire from the viewers. If a main channel changing instruction goes out of a range shown in FIG. 3, the list is to be scrolled. In the case of a main channel not involving digital broadcasting, an analog channel is to be selected.

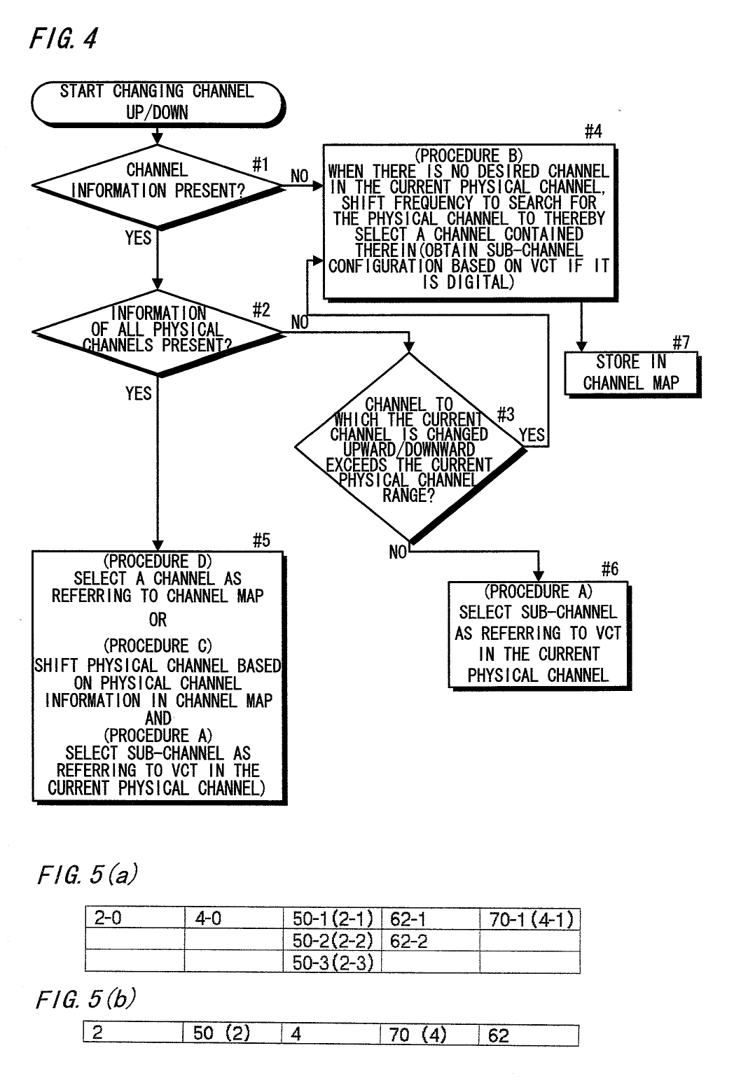

FIG. 4 shows a procedure for channel switch-over when a channel changing instruction is given from the remote controller 30 to the control unit 8. Although the channel changing instruction can be given by inputting a channel number, this example relates to processing using the channel UP/DOWN key 34 or OSD-display cursor operating keys 37 (37a to 37d). When having received a channel UP/DOWN operation instruction from the user, the control unit 8 checks for whether the channel information is stored in the memory 7 (#1). Upon power application or after the initialization of the memory 7, there is no channel information stored. If the channel information is not found (NO is answered at #1), technique B (first technique) is executed (#4). By this technique B, if a channel of interest is not found in the current physical channel, the control unit 8 does not check the channel map but shifts the frequency to search for a physical channel to thereby select a detected channel. If this channel is digital, the control unit 8 obtains a channel map from the VCT to then select the sub-channel and also store its information in the channel map (#7). Note here that when the channel UP/DOWN operation instruction is input, a sub-channel of the smallest/largest sub-channel number is selected respectively. If the detected physical channel is analog, the control unit 8 selects the channel and also stores its information in the channel map (#7). Note here that when the frequency is shifted down to the smallest channel frequency value, it shifts to the top.

If the channel information is found at #1 above, the control unit 8 checks for whether there is the channel information of all the physical channels (#2) and, if the channel information of some physical channels including the current physical channel is found, the control unit 8 then checks for whether a channel to which the channel UP/DOWN operation is performed goes out of the current physical channel range (storage range of the memory 7) (#3) and, if it does not (NO is answered at #3), execute technique A (second technique) (#6). If a channel UP/DOWN operation is instructed when the digital physical channel information is obtained, technique A is employed. By this technique A, the control unit 8 refers to the VCT in the current physical channel to thereby select a sub-channel. If the physical channel contains only one sub-channel or in the case of an analog broadcast, the channel to which the channel UP/DOWN operation is performed at #3 goes out of the current physical channel range (YES is answered at #3), the control unit 8 goes to #4 for channel selection by use of technique B (third technique).

By repeating #6 processing, and #4 processing to which the process skipped from #3, when a channel UP/DOWN operation is performed, the information of all the physical channels can be contained in the channel map. In this step, when the channels are changed upward/downward, the physical channels are all encountered, so that a physical channel is selected on the basis of the value of the channel number of the physical channels not of the virtual channels (if the virtual channels are used, the channel number slips, so that there is no guarantee that all the channels can be encountered).

When the information of all the physical channels is found at #2 (YES is answered at #2), that if when the channel information (VCT) contained in all of the physical channels is stored in the channel map, technique D (fourth technique) is performed (#5). By this technique D, the control unit 8 selects a channel by referring to the channel map. In place of this technique D, the following two methods may be combined: a method (technique C) of selecting a desired channel by searching physical channels based on the physical channel information in the channel map when the channel is to be changed over a plurality of physical channels and a method (technique A) of selecting a desired channel when the channel is to be changed in the same physical channel.

By performing these techniques, the user needs only to change the channel upward/downward in order to store the channel information in the memory 7 automatically.

The following will describe a specific method of selecting a channel by channel upward/downward operations. Suppose now that a broadcast of such a channel configuration (a number in the parentheses indicates a virtual channel number) shown in FIG. 5(a) is on the air. The first channel map in the receiver records no channel information therein. Upon power application, the receiver searches for physical channels (technique B). It actually searches them starting from the larger frequencies to thereby find channel 70-1 (virtual channel 4-1) first and select this channel. This is registered in the channel map of physical channel 70. Then, when the receiver moves the channel number downward, it refers to the VCT to thereby know that this physical channel has only one sub-channel, so that it utilizes technique B in order to select another physical channel. It actually refers to a VCT of physical channel 62 to thereby select channel 62-2. Then, when the receiver moves the channel number downward further, it selects channel 62-1 using technique A.

Thus, when the channel number is moved downward with channel 50-1 as selected, the next channel number to be selected is channel 4-0 because it is selected referring to the physical channel, although the virtual channel number is channel 2-1. Since the channel selection range is limited, after this procedure is used to change the channels upward and downward to obtain the information of all the physical channels, the following two channel selecting methods are employed. By one of them (technique D), the same information as the above-mentioned broadcasting configuration is saved in the channel map, based on virtual channel information of which is selected a desired channel. That is, channel 5-1 is recognized as channel 2-1, from which the channel number is changed downward to thereby select channel 2-0. By the other method (combination of techniques C and A), such the information of such a broadcasting configuration as shown in FIG. 5(b) is utilized. In this order are selected the channel. A plurality of physical channels, if any, is searched for using technique C, so that if the changing destination is a digital channel, technique A is used to search for it as referring to the VCT.

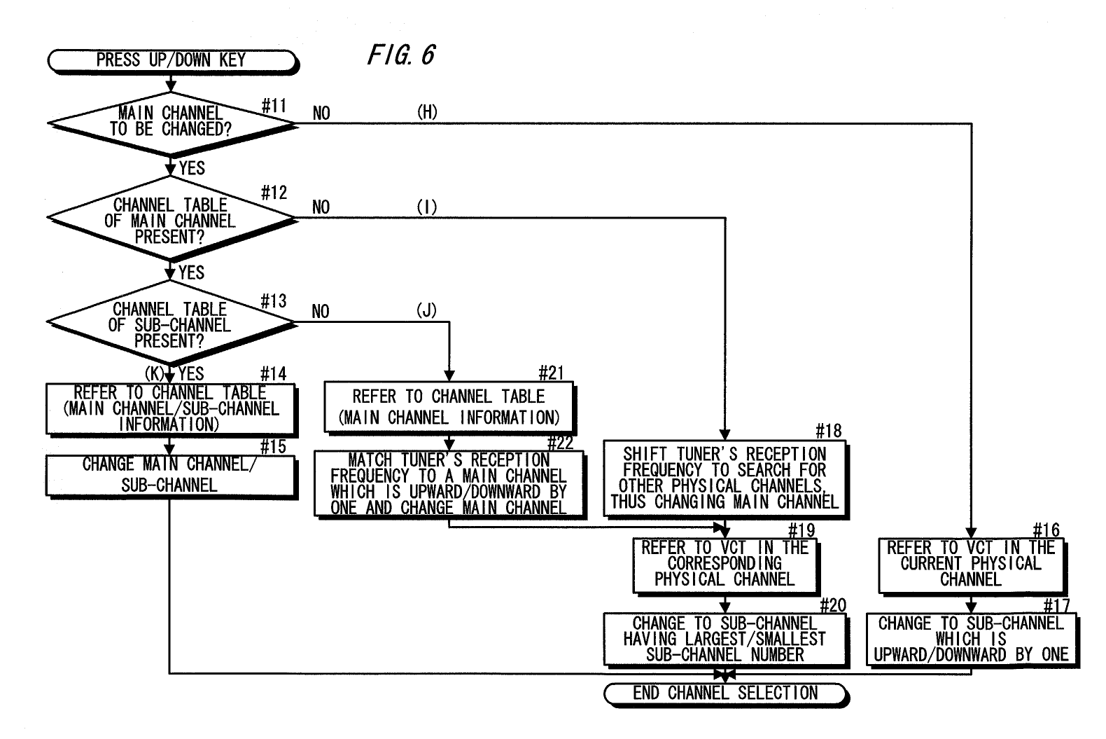

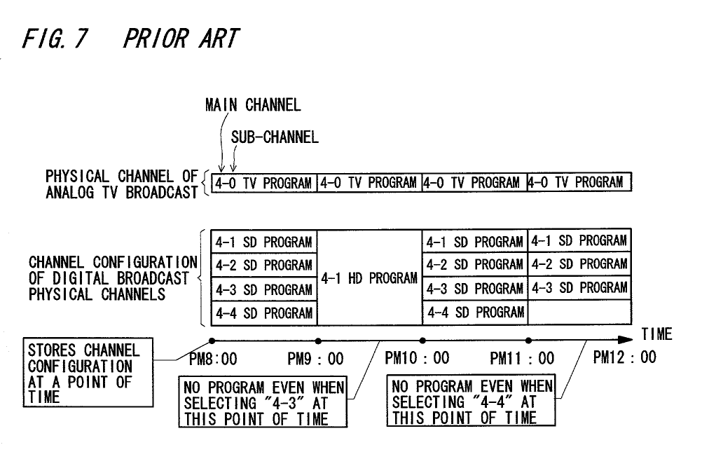

Next, the following will describe a processing procedure different from the above for switching a channel by changing the channel number upward/downward. FIG. 6 shows a flowchart for the processing. In this example, a desired channel is selected using any appropriate one of the following first through fourth procedures based on how to the channel map (channel table) is held and what the changed contents are.

By the first procedure, if a sub-channel in the current main channel is to be changed (NO is answered at #11) (H), the process refers to a VCT in the current main channel (#16) to thereby select an upward/downward sub-channel (#17).

By the second procedure for changing a main channel, if there is no channel data of changing destination main channel and sub-channels (NO is answered at #12) (I), the process shifts the reception frequency upward/downward to thereby research for other physical channels (#18), so that it then refers to a VCT of a detected physical channel (#19), thus selecting a sub-channel having the largest/smallest sub-channel number (#20).

By the third procedure for changing a main channel, if there is channel data of changing destination main channel but no sub-channel data (NO is answered at #13) (J), the process refers to the main channel data to thereby change the main channel (#21, #22) and refers to a detected VCT in the corresponding physical channel (#19), this selecting a sub-channel; having the largest/smallest sub-channel number (#20).

By the fourth procedure for changing a main channel also, if there is channel data of changing destination main channel and sub-channels (YES is answered at #13) (K), the process refers to this channel data (#14) to thereby change the main channel and the sub-channel (#15), thus selecting a desired channel.

By using any appropriate one of the above-mentioned procedures, a desired channel can be selected appropriately by changing channel number upward/downward even with a digital/analog broadcasting receiver. The invention is not limited to the configurations of the above embodiments but may be changed variously; for example, the receiver 1 may be integrated in the body of a television receiver or a video cassette recorder (VCR) in configuration.

What is claimed is:

1. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital-broadcasting signal having, in one main channel, one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, appropriately uses any one of the following four techniques of:
a first technique, by which when there is no channel information in the memory, the frequency is shifted to search for a desired physical channel to thereby select a channel contained in a detected physical channel and also store information of the channel in the channel map;
a second technique, by which when there is channel information of a current physical channel in the memory, a VCT thereof is referenced to select a sub-channel in the physical channel;
a third technique, by which the first technique is employed when a channel to which the current channel is upward/downward changed by the second technique goes out of the current physical channel range; and
a fourth technique, by which when information of all the channels is stored in the channel map in the memory, it is taken either a method of selecting a desired channel in referring to the channel map, or a method of selecting a desired channel based on the physical channel information in the channel map among the channels over a plurality of physical channels and of employing the second technique of selecting a desired channel among the channels in the same physical channel.

2. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one main channel, one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, appropriately uses any one of the following four techniques of:
a first technique, by which when there is no channel information in the memory, the frequency is shifted to search for a desired physical channel to thereby select a channel contained in a detected physical channel and also store information of the channel in the channel map;
a second technique, by which when there is channel information of a current physical channel in the memory, a VCT thereof is referenced to select a sub-channel in the physical channel;
a third technique, by which the first technique is employed when a channel to which the current channel is upward/downward changed by the second technique goes out of the current physical channel range; and
a fourth technique, by which when information of all the channels is stored in the memory, a desired channel is selected on the basis of the physical channel information in the channel map among the channels over a plurality of physical channels and, it is selected by the second technique among the channels in the same physical channel.

3. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one main channel, one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, appropriately uses any one of the following four techniques of:
a first technique, by which when there is no channel information in the memory, the frequency is shifted to search for a desired physical channel to thereby select a channel contained in a detected physical channel and also store information of the channel in the channel map;
a second technique, by which when there is channel information of a current physical channel in the memory, a VCT thereof is referenced to select a sub-channel in the physical channel;
a third technique, by which the first technique is employed when a channel to which the current channel is upward/downward changed by the second technique goes out of the current physical channel range; and
a fourth technique, by which when information of all the channels is stored in the memory, a desired channel is selected by referring to the channel map.

4. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one main channel, one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, selectively uses the channel information obtaining and channel selecting techniques corresponding to the contents of the channel map of the channel upward/downward changing destination held in the memory and also stores the channel information in the channel map.

5. The digital/analog broadcasting receiver equipped with the channel selection device according to claim 1, for receiving a digital broadcast according to the ATSC (Advanced Television Systems Committee) standard and an analog broadcast according to the NTSC (National Television Systems Committee) standard.

6. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one physical channel (main channel), one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, selects a desired channel by selectively using any one of the following first through fourth procedures corresponding to the channel changing contents and how the data table containing the VCT is held in the memory:
a first procedure, by which when the sub-channel is changed in the current main channel, the VCT in the current physical channel is referenced to select an upward/downward sub-channel;
a second procedure, by which when a main channel is to be changed and if there is no channel data of a main channel to which the current main channel is to be changed and the sub-channel, the reception frequency is shifted upward/downward to thereby search for other physical channels and then refers to the VCT of a detected physical channel, thus selecting a sub-channel having the largest/smallest sub-channel number;
a third procedure, by which when a main channel is to be changed and if there is the channel data of the main channel to which the current main channel is to be changed and there is no sub-channel data, the main channel data is referenced to change the main channel and then refers to the VCT detected in the corresponding physical channel, thus selecting a sub-channel having the largest/smallest sub-channel number; and
a fourth procedure, by which when a main channel is to be changed and there is the channel data of a main channel to which the current main channel is to be changed and the sub-channel, the channel data is referenced to change the main channel and the sub-channel, thus selecting the channel.

7. A channel selection device used in a digital/analog broadcasting receiver comprising: a receiver for receiving an encoded digital/analog broadcasting signal originated from a broadcasting station; a digital/analog decoder for decoding the digital/analog broadcasting signal received from the receiver and then outputting the signal to a display; a memory for storing, as a channel map, channel information contained in the broadcasting signal decoded by the digital decoder; a control unit for controlling the sections of the receiver such that, upon reception of the channel selection instruction from the input device, the receiver receives the broadcasting signal of a selected channel; and an input device for inputting a user's instruction for channel selection to the control unit; wherein the receiver receives the digital broadcast and an analog broadcast which are originated through different physical channels, the digital broadcasting signal having, in one physical channel (main channel), one or a plurality of sub-channels for originating contents therethrough and also having a VCT (Virtual Channel Table) containing virtual channel information providing the sub-channels with a correlation with an analog broadcasting physical channel; characterized in that,
the control unit, when trying to select a channel based on a channel upward/downward changing instruction sent from the input device, selects a desired channel by selectively using any one of the following procedures:
referring to the VCT contained in the current physical channel to change the sub-channel when a sub-channel in the current main channel is to be changed;
searching for other physical channels to refer to a detected VCT, thus changing the sub-channel when a main channel is to be changed, and when there is no channel data of the main channel and the sub-channel;
referring to the main channel data to change the main channel and referring to the corresponding VCT, thus changing the sub-channel when there is the main channel data but not the sub-channel data; and
referring to the channel data to change each of the channels when there is the channel data of the main channel and the sub-channel.

8. The digital/analog broadcasting receiver equipped with the channel selection device according to claim 6, for receiving a digital broadcast according to the ATSC (Advanced Television Systems Committee) standard and an analog broadcast according to the NTSC (National Television Systems Committee) standard.
